(19) United States
(12) Patent Application Publication
(10) Pub. No.: US 2011/0018619 A1
(43) Pub. Date: Jan. 27, 2011

(54) INTEGRATED NEGATIVE VOLTAGE GENERATOR

(75) Inventor: Marco Cassia, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/618,544

(22) Filed: Nov. 13, 2009

Related U.S. Application Data
(60) Provisional application No. 61/227,725, filed on Jul. 22, 2009.

(51) Int. Cl. G05F 3/02

(52) U.S. Cl. 327/537

(57) ABSTRACT

A negative voltage generator with AC coupled control signals is described. In an exemplary design, the generator includes four switches (which may be implemented with MOS transistors) and a capacitor. A first switch is coupled between a positive input voltage and a first end of the capacitor. A second switch is coupled between the first end of the capacitor and circuit ground. A third switch is coupled between a second end of the capacitor and circuit ground. A fourth switch is coupled between the second end of the capacitor and a negative output voltage. The first and second switches are controlled by first and second control signals, respectively. The third and fourth switches are controlled by first and second AC coupled control signals, respectively. The first and second AC coupled control signals may be generated by AC coupling the first and second control signals, respectively, and applying appropriate biasing.

### CLAIM OF PRIORITY UNDER 35 U.S.C. §119

The present application for patent claims priority to Provisional U.S. Application Ser. No. 61/227,725, entitled “INTEGRATED NEGATIVE VOLTAGE GENERATOR,” filed Jul. 22, 2009, assigned to the assignee hereof, and expressly incorporated herein by reference.

### BACKGROUND

I. Field

The present disclosure relates generally to electronics, and more specifically to a voltage generator.

II. Background

An electronics device (e.g., a cellular phone) may have a voltage generator that receives a first voltage and generates a second voltage different from the first voltage. The voltage generator may be implemented on an integrated circuit (IC). It may be desirable to implement the voltage generator as efficiently as possible in order to reduce power dissipation, cost, and circuit area.

### BRIEF DESCRIPTION OF THE DRAWINGS

FIG. 1 shows a switched-capacitor negative voltage generator.

FIG. 2 shows control signals for the negative voltage generator in FIG. 1.

FIG. 3 shows a negative voltage generator implemented with MOS transistors.

FIG. 4 shows control signals for the negative voltage generator in FIG. 3.

FIG. 5 shows a negative voltage generator with AC coupled control signals.

FIG. 6 shows control signals for the negative voltage generator in FIG. 5.

FIGS. 7A and 7B show operation of the negative voltage generator in FIG. 5.

FIG. 8 shows another negative voltage generator with AC coupled control signals.

FIG. 9 shows a wireless communication device.

FIG. 10 shows a process for generating a voltage.

### DETAILED DESCRIPTION

The word “exemplary” is used herein to mean “serving as an example, instance, or illustration.” Any design described herein as “exemplary” is not necessarily to be construed as preferred or advantageous over other designs.

A negative voltage generator that can be efficiently implemented on an integrated circuit is described herein. The negative voltage generator receives a positive input voltage and provides a negative output voltage. The negative output voltage may be used for various applications such as for logic circuits operating with a negative supply voltage, for controlling switches, etc.

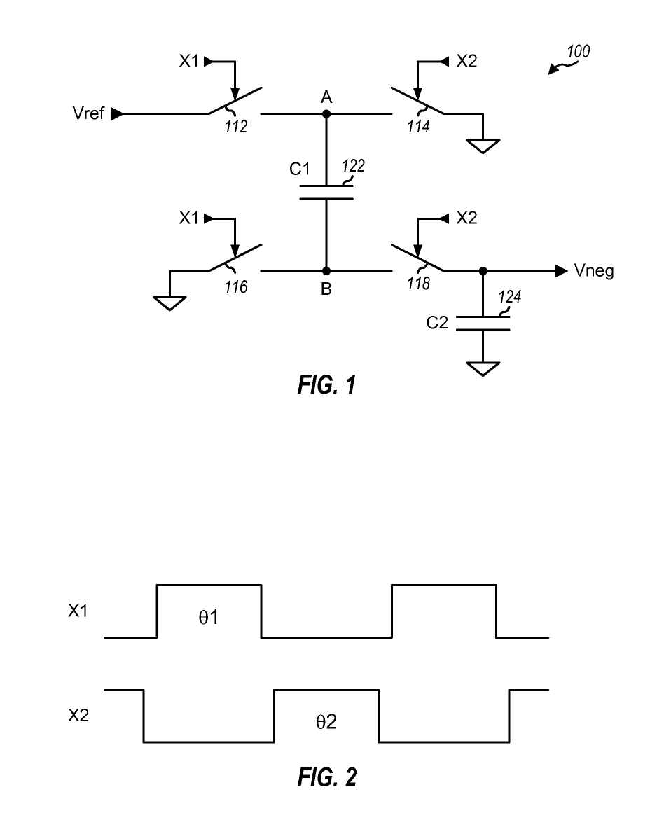

FIG. 1 shows a schematic diagram of a negative voltage generator 100 implemented with a switched-capacitor circuit. Within generator 100, a switch 112 is coupled between an input of generator 100 and node A. A switch 114 is coupled between node A and circuit ground. A capacitor 122 with a capacitance of C1 is coupled between node A and node B. A switch 116 is coupled between node B and circuit ground. A switch 118 is coupled between node B and an output of generator 100. Switches 112 and 116 are controlled by an X1 control signal, and switches 114 and 118 are controlled by an X2 control signal. A capacitor 124 with a capacitance of C2 is coupled between the output of generator 100 and circuit ground. A positive input voltage, Vref, is provided to the input of generator 100, and a negative output voltage, Vneg, is provided by the output of generator 100.

FIG. 2 shows a timing diagram of the control signals for negative voltage generator 100 in FIG. 1. The X1 control signal is at logic high during a first phase θ1 and is at logic low for the remaining time. The X2 control signal is at logic high during a second phase θ2 and is at logic low for the remaining time. The first phase is non-overlapping with the second phase, as shown in FIG. 2.

Referring back to FIG. 1, negative voltage generator 100 operates as follows. During the first phase θ1, the X1 control signal is at logic high, the X2 control signal is at logic low, switches 112 and 116 are closed, and switches 114 and 118 are opened. Capacitor 122 has its bottom plate connected to circuit ground via switch 116, and the Vref voltage charges capacitor 122 to Vref. During the second phase θ2, the X1 control signal is at logic low, the X2 control signal is at logic high, switches 112 and 116 are opened, and switches 114 and 118 are closed. Capacitor 122 has its top plate connected to circuit ground via switch 114 and provides a negative voltage of Vneg, which should be close to −Vref.

Negative voltage generator 100 generates a negative voltage by (i) charging capacitor 122 with a positive voltage during the first phase with the bottom plate connected to circuit ground and (ii) discharging capacitor 122 during the second phase with the top plate connected to circuit ground. Capacitor 124 stores charges from capacitor 122 during the second phase. Capacitor 124 also provides the Vneg voltage during the first phase when capacitor 122 is being charged.

Negative voltage generator 100 may be implemented in various manners. For example, switches 112 to 118 may be implemented with transistors or some other electronics switches. Appropriate control signals may be provided to the switches to turn these switches on or off at the appropriate time.

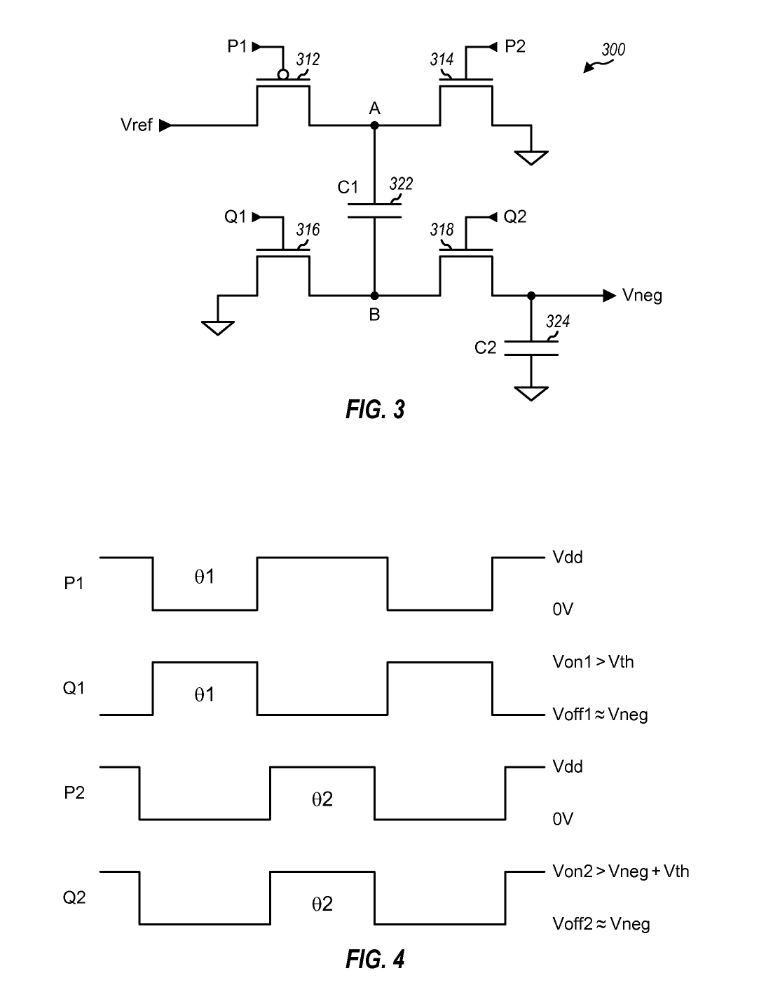

FIG. 3 shows a schematic diagram of a negative voltage generator 300 comprising switches implemented with metal oxide semiconductor (MOS) transistors. Within generator 300, a P-channel MOS (PMOS) transistor 312 has one source/drain terminal coupled to an input of generator 300, the other source/drain terminal coupled to node A, and a gate receiving a P1 control signal. An N-channel MOS (NMOS) transistor 314 has one source/drain terminal coupled to node A, the other source/drain terminal coupled to circuit ground, and a gate receiving a P2 control signal. A capacitor 322 is coupled between node A and node B. An NMOS transistor 316 has one source/drain terminal coupled to circuit ground, the other source/drain terminal coupled to node B, and a gate receiving a Q1 control signal. An NMOS transistor 318 has one source/drain terminal coupled to node B, the other source/drain terminal coupled to the output of generator 300, and a gate receiving a Q2 control signal. A capacitor 324 is coupled between the output of generator 300 and circuit ground. A positive input voltage, Vref, is provided to the input of generator 300, and a negative output voltage, Vneg, is provided by the output of generator 300.

FIG. 4 shows a timing diagram of the control signals for negative voltage generator 300 in FIG. 3. The P1 control signal is at logic low and the Q1 control signal is at logic high during a first phase θ1, and these control signals are at the opposite logic for the remaining time. The P2 and Q2 control signals are at logic high during a second phase θ2 and are at logic low for the remaining time. The first phase is non-overlapping with the second phase, as shown in FIG. 4.

FIG. 4 also shows the voltage levels of the P1, P2, Q1 and Q2 control signals. The P1 and P2 control signals may have a voltage level of Vdd for logic high and a voltage level of 0 Volts (V) for logic low, where Vdd is a power supply voltage. The Q1 control signal may have a voltage level greater than Vth for logic high and a voltage level of approximately Vneg for logic low, where Vth is a threshold voltage for NMOS transistor 316. The Q2 control signal may have a voltage level greater than Vneg+Vth for logic high and a voltage level of approximately Vneg for logic low. Vth is typically dependent on IC process and may be about 0.5V to 0.7V.

Referring back to FIG. 3, the source and drain of PMOS transistor 312 and the source and drain of NMOS transistor 314 observe either the Vref voltage or 0V. Hence, the P1 and P2 control signals for PMOS transistor 312 and NMOS transistor 314 can have voltage levels of Vdd and 0V. NMOS transistor 316 observes 0V at node B when it is turned on during the first phase and observes Vneg at node B when it is turned off during the second phase. Hence, the Q1 control signal for NMOS transistor 316 should be greater than Vth during the first phase to turn on NMOS transistor 316 and should be approximately Vneg during the second phase to turn off NMOS transistor 316. NMOS transistor 318 observes 0V at node B when it is turned off during the first phase and observes Vneg at node B when it is turned on during the second phase. Hence, the Q2 control signal for NMOS transistor 318 should be greater than Vneg+Vth during the second phase to turn on NMOS transistor 318 and should be approximately Vneg during the first phase to turn off NMOS transistor 318.

Level shifters may be used to generate the Q1 and Q2 control signals at the proper voltage levels to properly control NMOS transistors 316 and 318. The level shifters may utilize the Vneg voltage provided by generator 300 to generate the Q1 and Q2 control signals. The level shifters would then consume some of the current provided by generator 300, which may then adversely impact the performance of generator 300. The performance degradation may be more severe if generator 300 is implemented on-chip and has a limited amount of integrated capacitance and hence limited current capability. The current consumed by the level shifters during switching may reduce the efficiency of generator 300, raise the average output voltage provided by generator 300, and cause spurs in the Vneg voltage, all of which may be undesirable. The level shifters would need to generate non-overlapping Q1 and Q2 control signals that should be time aligned with the P1 and P2 control signals. The level shifters typically have some delay and may be implemented with a complicated design in order to account for this delay in generating the Q1 and Q2 control signals. Furthermore, the clock rate of negative voltage generator 300 may be limited by the speed of the level shifters. There may be other undesirable effects associated with the use of level shifters to generate the Q1 and Q2 control signals.

In an aspect, a negative voltage generator may utilize alternating current (AC) coupled control signals to control MOS transistors acting as switches. The use of AC coupled control signals may avoid the need to use level shifters, which may avoid the undesirable effects described above.

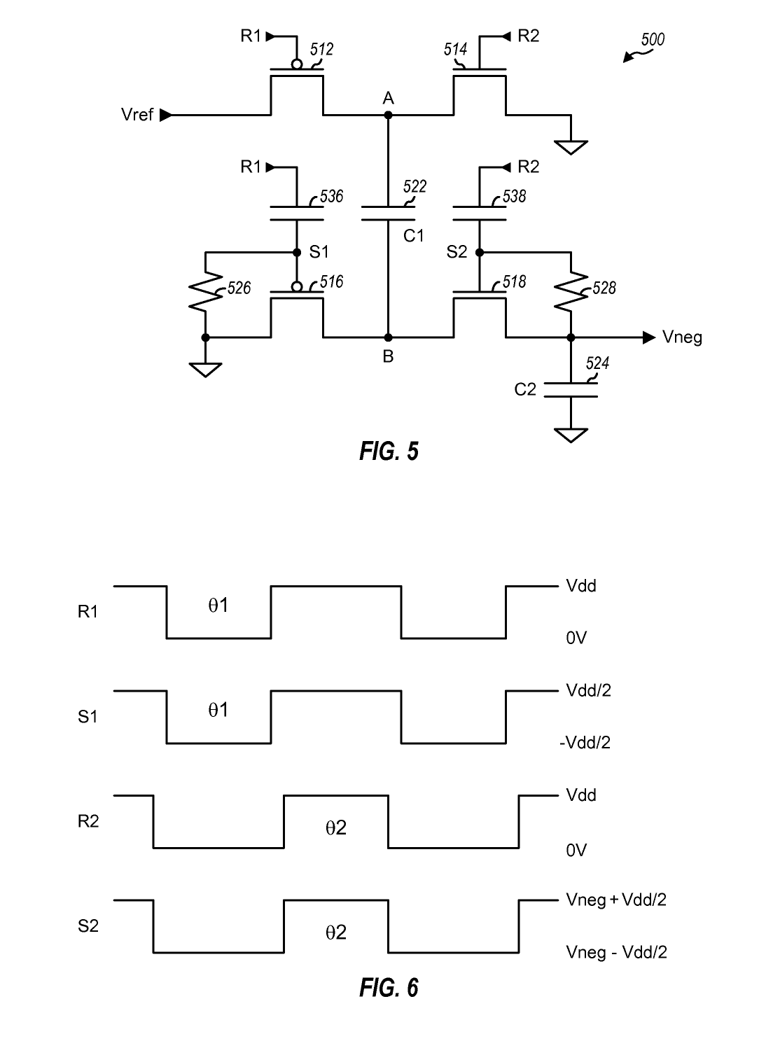

FIG. 5 shows a schematic diagram of an exemplary design of a negative voltage generator 500 utilizing alternating current (AC) coupled control signals. Within generator 500, a PMOS transistor 512 has one source/drain terminal coupled to an input of generator 500, the other source/drain terminal coupled to node A, and a gate receiving an R1 control signal. An NMOS transistor 514 has one source/drain terminal coupled to node A, the other source/drain terminal coupled to circuit ground, and a gate receiving an R2 control signal. A capacitor 522 is coupled between node A and node B.

A PMOS transistor 516 has one source/drain terminal coupled to circuit ground, the other source/drain terminal coupled to node B, and a gate coupled to one end of an AC coupling capacitor 536. Capacitor 536 receives the R1 control signal at the other end and provides an S1 AC coupled control signal to the gate of PMOS transistor 516. A resistor 526 is coupled between the gate of PMOS transistor 516 and circuit ground. An NMOS transistor 518 has one source/drain terminal coupled to node B, the other source/drain terminal coupled to the output of generator 500, and a gate coupled to one end of an AC coupling capacitor 538. Capacitor 538 receives the R2 control signal at the other end and provides an S2 AC coupled control signal to the gate of NMOS transistor 518. A resistor 528 is coupled between the gate of NMOS transistor 518 and the output of generator 500. A capacitor 524 is coupled between the output of generator 500 and circuit ground. A positive input voltage, Vref, is provided to the input of generator 500, and a negative output voltage, Vneg, is provided by the output of generator 500.

FIG. 6 shows a timing diagram of the control signals for negative voltage generator 500 in FIG. 5. The R1 and S1 control signals are at logic low during a first phase θ1 and are at logic high for the remaining time. The R2 and S2 control signals are at logic high during a second phase θ2 and are at logic low for the remaining time. The first phase is non-overlapping with the second phase, as shown in FIG. 6.

FIG. 6 also shows the voltage levels of the R1, R2, S1 and S2 control signals. The R1 and R2 control signals may have a voltage level of Vdd for logic high and a voltage level of 0V for logic low. The bottom plate of capacitor 536 is biased at circuit ground via resistor 526. The S1 control signal may be approximately Vdd/2 when the R1 control signal is at logic high and may be approximately −Vdd/2 when the R1 control signal is at logic low. Resistor 526 and capacitor 536 essentially shift the average voltage of the S1 control signal to 0V at the gate of PMOS transistor 516. The bottom plate of capacitor 538 is biased at the Vneg voltage via resistor 528. The S2 control signal may be approximately Vneg+Vdd/2 when the R2 control signal is at logic high and may be approximately Vneg−Vdd/2 when the R2 control signal is at logic low. Resistor 528 and capacitor 538 essentially shift the average voltage of the S2 control signal to Vneg at the gate of NMOS transistor 518.

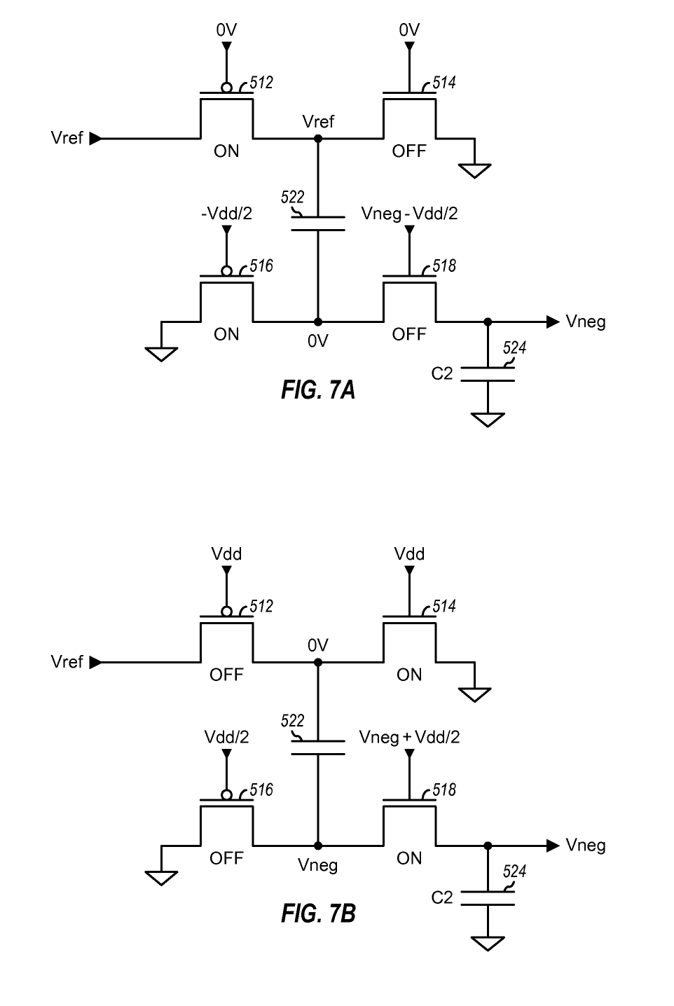

FIG. 7A shows operation of negative voltage generator 500 during the first phase. The R1 control signal is at logic low, and PMOS transistor 512 is turned on by 0V at its gate. The S1 control signal is also at logic low, and PMOS transistor 516 is turned on by −Vdd/2 at its gate. The R2 control signal is at logic low, and NMOS transistor 514 is turned off by 0V at its gate. The S2 control signal is also at logic low, and NMOS transistor 518 is turned off by Vneg−Vdd/2 at its gate. Capacitor 522 has its bottom plate connected to circuit ground via PMOS transistor 516, and the Vref voltage charges capacitor 522 to Vref.

FIG. 7B shows operation of negative voltage generator 500 during the second phase. The R1 control signal is at logic high, and PMOS transistor 512 is turned off by Vdd at its gate. The S1 control signal is also at logic high, and PMOS transistor 516 is turned off by Vdd/2 at its gate. The R2 control signal is at logic high, and NMOS transistor 514 is turned on by Vdd at its gate. The S2 control signal is also at logic high, and NMOS transistor 518 is turned on by Vneg+Vdd/2 at its gate. Capacitor 522 has its top plate connected to circuit ground via NMOS transistor 514 and provides its charge via NMOS transistor 518.

As shown in FIGS. 5, 7A and 7B, negative voltage generator 500 utilizes only two phases for the R1 and R2 control signals. Furthermore, level shifters are not needed to generate the control signals for MOS transistors 516 and 518. This may greatly simplify the design of negative voltage generator 500. Generator 500 can also utilize smaller capacitors 522 and 524, which may be desirable for implementation on an integrated circuit. In an exemplary design, capacitors 522 and 524 may each be between 50 to 100 pico Farads (pF), and capacitors 536 and 538 may each be between 5 to 15 pF. Other capacitor sizes may also be used for capacitors 522, 524, 526 and 536. In general, larger capacitors 522 and 524 may result in (i) smaller glitches in the Vneg voltage during switching of the MOS transistors and (ii) more output current. Capacitor 524 may be larger than capacitor 522 to reduce glitches and provide more current drive but would then need more time to charge.

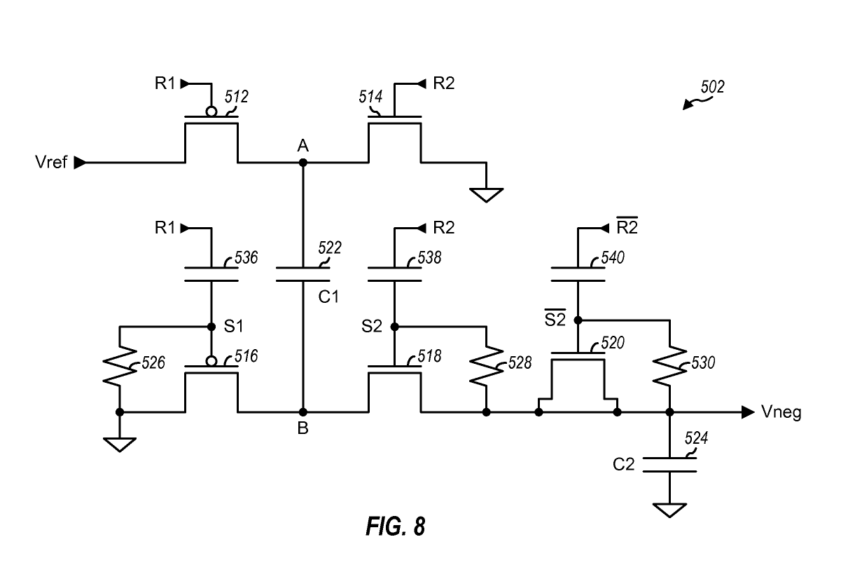

FIG. 8 shows a schematic diagram of another exemplary design of a negative voltage generator 502 utilizing AC coupled control signals. Generator 502 includes all circuit components in generator 500 in FIG. 5. Generator 502 further includes an NMOS transistor 520 having both source/drain terminals coupled to the output of generator 502 and a gate coupled to one end of an AC coupling capacitor 540. Capacitor 540 receives an inverted R2 control signal, R̅2̅, at the other end and provides an inverted S2 AC coupled control signal, S̅2̅, to the gate of NMOS transistor 520. A resistor 530 is coupled between the gate of NMOS transistor 520 and the output of generator 502.

NMOS transistor 520 may be used to minimize charge injection via NMOS transistor 518. NMOS transistor 520 may be turned on during the first phase by the S2 control signal and may absorb the charge from NMOS transistor 518 when NMOS transistor 518 is switched off. This may then mitigate glitches at the output of generator 502.

FIGS. 5 and 8 show two exemplary designs of negative voltage generators 500 and 502. These exemplary designs use PMOS transistors 512 and 516 and NMOS transistors 514 and 518 for four switches coupled to capacitor 522. The four switches may also be implemented with other transistors. For example, NMOS transistors may be used in place of PMOS transistors 512 and 516.

The exemplary designs shown in FIGS. 5 and 8 assume that Vdd/2 is greater than the magnitude of the threshold voltage, |Vth|, which may ensure that PMOS transistor 516 and NMOS transistor 518 can be turned on and off with the AC biasing shown in FIGS. 5 and 8. The control voltage at the gate of PMOS transistor 516 may be brought lower by coupling the gate of PMOS transistor 516 to a center tap of a resistive divider coupled between circuit ground and Vneg. Similarly, the control voltage at the gate of NMOS transistor 518 may be brought higher by coupling the gate of NMOS transistor 518 to a center tap of a resistive divider coupled between circuit ground and Vneg.

The negative voltage generator described herein may be used for various electronics devices such as wireless communication devices, cellular phones, personal digital assistants (PDAs), handheld devices, wireless modems, laptop computers, cordless phones, broadcast receivers, Bluetooth devices, consumer electronics devices, etc. The use of the negative voltage generator in a wireless communication device, which may be a cellular phone or some other device, is described below.

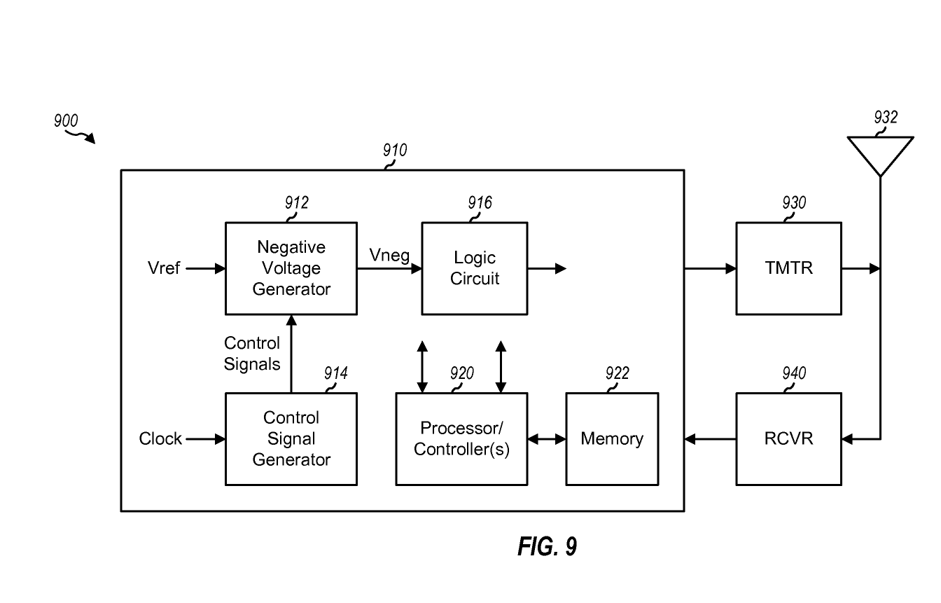

FIG. 9 shows a block diagram of an exemplary design of a wireless communication device 900. In this exemplary design, wireless device 900 includes an integrated circuit 910, a transmitter (TMTR) 930, and a receiver (RCVR) 940 that support bi-directional wireless communication. Integrated circuit 910 may be an application specific integrated circuit (ASIC) or some other type of IC.

Within integrated circuit 910, a negative voltage generator 912 receives a Vref voltage and generates a Vneg voltage. Generator 912 may be implemented with generator 500 in FIG. 5, generator 502 in FIG. 8, or some other negative voltage generator. A control signal generator 914 receives a clock and generates control signals (e.g., the R1 and R2 control signals) for negative voltage generator 912. A logic circuit 916 receives the Vneg voltage from generator 912 and may use the Vneg voltage as a lower power supply voltage, Vss. Logic circuit 916 may perform various functions such as turning off switches. Processor/controller(s) 920 may perform various functions for wireless device 900, e.g., processing for data being transmitted or received. A memory 922 may store program codes and data for processor/controller(s) 920. Integrated circuit 910 may also include other modules, processors, memories, etc.

Transmitter 930 receives an analog output signal from integrated circuit 910 and processes (e.g., amplifies, filters, and upconverts) the analog output signal to generate an output radio frequency (RF) signal, which is transmitted via an antenna 932. Receiver 940 receives an input RF signal from antenna 932 and processes (amplifies, filters, and downconverts) the input RF signal and provides an analog input signal to integrated circuit 910. Transmitter 930 and/or receiver 940 may include a negative voltage generator or may receive the Vneg voltage from generator 912. The Vneg voltage may be used to turn off switches.

As shown in FIG. 9, a compact negative voltage generator 912 may generate the Vneg voltage, which may be used as the Vss voltage for logic circuit 916. A small amount of integrated capacitance may be available on integrated circuit 910. Negative voltage generator 912 may use AC coupled control signals as described above and may avoid using level shifters. This may allow generator 912 to avoid the disadvantages associated with the use of the level shifters, including lower efficiency due to use of some charge from the Vneg voltage to power the level shifters, spurs in the Vneg voltage due to transitions in the level shifters, limited operating speed of the negative voltage generator due to the speed of the level shifters, etc.

In an exemplary design, an apparatus (e.g., an integrated circuit or some other device) may include first, second, third and fourth switches and a capacitor, which may collectively implement a voltage generator. The first switch may be coupled between a first voltage and a first end of the capacitor and may be controlled based on a first control signal. The second switch may be coupled between the first end of the capacitor and circuit ground and may be controlled based on a second control signal. The third switch may be coupled between a second end of the capacitor and circuit ground and may be controlled based on a first AC coupled control signal. The fourth switch may be coupled between the second end of the capacitor and a second voltage and may be controlled based on a second AC coupled control signal. The first voltage may be a positive voltage, and the second voltage may be a negative voltage.

In an exemplary design, the first, second, third and fourth switches may comprise first, second, third and fourth MOS transistors, respectively, e.g., MOS transistors 512, 514, 516 and 518, respectively, in FIG. 5. A first AC coupling capacitor (e.g., capacitor 536) may be coupled to the gate of the third MOS transistor, may receive the first control signal (e.g., the R1 control signal), and may provide the first AC coupled control signal (e.g., the S1 control signal) to the third MOS transistor. A second AC coupling capacitor (e.g., capacitor 538) may be coupled to the gate of the fourth MOS transistor, may receive the second control signal (e.g., the R2 control signal), and may provide the second AC coupled control signal (e.g., the S2 control signal) to the fourth MOS transistor. A first resistor (e.g., resistor 526) may be coupled between the gate of the third MOS transistor and circuit ground and may bias the second capacitor with 0V. A second resistor (e.g., resistor 528) may be coupled between the gate of the fourth MOS transistor and the second voltage and may bias the third capacitor with the second voltage. A fifth MOS transistor (e.g., MOS transistor 520) may have a source and a drain coupled to the second voltage and may be turned on or off based on a third AC coupled control signal (e.g., the S̅2̅ control signal), as shown in FIG. 8.

In an exemplary design, the first and third switches may comprise first and second PMOS transistors, respectively, and the second and fourth switches may comprise first and second NMOS transistors, respectively, e.g., as shown in FIG. 5. The first and second control signals may have non-negative voltage levels, e.g., Vdd and 0V. The first AC coupled control signal may have positive and negative voltage levels, e.g., Vdd/2 and −Vdd/2. The second AC coupled control signal may have negative voltage levels, e.g., Vneg+Vdd/2 and Vneg−Vdd/2. The second PMOS transistor may be turned on during a first phase by a negative voltage (e.g., −Vdd/2) on the first AC coupled control signal and may be turned off during a second phase by a positive voltage (e.g., Vdd/2) on the first AC coupled control signal, e.g., as shown in FIGS. 7A and 7B. The second NMOS transistor may be turned off during the first phase by a low voltage on the second AC coupled control signal and may be turned on during the second phase by a high voltage on the second AC coupled control signal. The low voltage (e.g., Vneg−Vdd/2) may be below the second voltage (e.g., Vneg), and the high voltage (e.g., Vneg+Vdd/2) may be above the second voltage. The first and second AC coupled control signals may also have other voltage levels, which may be dependent on the type of transistors used for the third and fourth switches.

In another exemplary design, an integrated circuit may include first, second, third and fourth MOS transistors. The first MOS transistor may be coupled between a first voltage and a first end of a capacitor and may be turned on or off based on a first control signal. The second MOS transistor may be coupled between the first end of the capacitor and circuit ground and may be turned on or off based on a second control signal. The third MOS transistor may be coupled between a second end of the capacitor and circuit ground and may be turned on or off based on a first AC coupled control signal. The fourth MOS transistor may be coupled between the second end of the capacitor and a second voltage and may be turned on or off based on a second AC coupled control signal. The AC coupled control signals may be generated as described above.

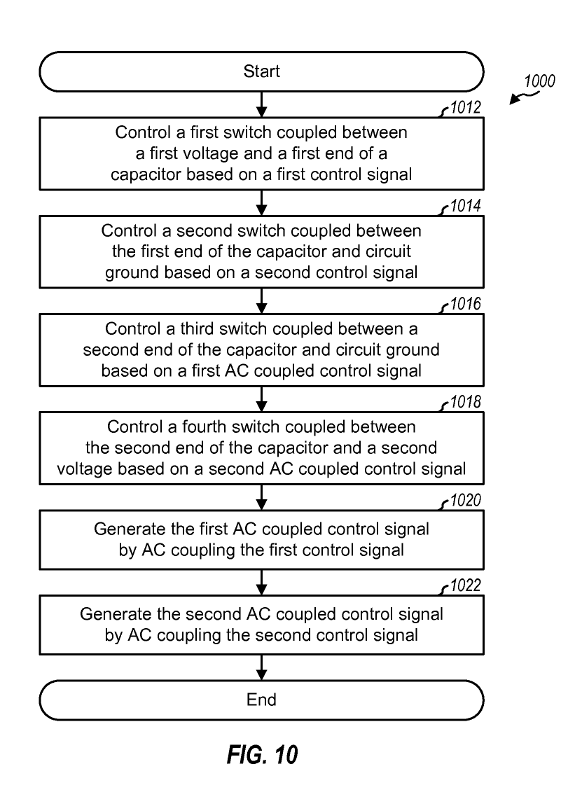

FIG. 10 shows an exemplary design of a process 1000 for generating a voltage. A first switch coupled between a first voltage and a first end of a capacitor may be controlled based on a first control signal (block 1012). A second switch coupled between the first end of the capacitor and circuit ground may be controlled based on a second control signal (block 1014). A third switch coupled between a second end of the capacitor and circuit ground may be controlled based on a first AC coupled control signal (block 1016). A fourth switch coupled between the second end of the capacitor and a second voltage may be controlled based on a second AC coupled control signal (block 1018). The first AC coupled control signal may be generated by AC coupling the first control signal and may have an average voltage of 0V (block 1020). The second AC coupled control signal may be generated by AC coupling the second control signal and may have an average voltage determined by the second voltage (block 1022). The switches may comprise MOS transistors, which may be turned on and off as described above.

The negative voltage generator described herein may be implemented on an IC, an analog IC, an RF IC (RFIC), a mixed-signal IC, an ASIC, a printed circuit board (PCB), an electronics device, etc. The negative voltage generator may also be fabricated with various IC process technologies such as complementary metal oxide semiconductor (CMOS), NMOS, PMOS, bipolar junction transistor (BJT), bipolar-CMOS (BiCMOS), silicon germanium (SiGe), gallium arsenide (GaAs), etc.

An apparatus implementing the negative voltage generator described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. An apparatus comprising:
a first switch coupled between a first voltage and a first end of a capacitor, the first switch is controlled based on a first control signal;
a second switch coupled between the first end of the capacitor and circuit ground, the second switch is controlled based on a second control signal;
a third switch coupled between a second end of the capacitor and circuit ground, the third switch is controlled based on a first AC coupled control signal; and
a fourth switch coupled between the second end of the capacitor and a second voltage, the fourth switch is controlled based on a second AC coupled control signal.

2. The apparatus of claim 1, the first voltage is a positive voltage, and the second voltage is a negative voltage.

3. The apparatus of claim 1, the first, second, third and fourth switches comprise first, second, third and fourth metal oxide semiconductor (MOS) transistors, respectively.

4. The apparatus of claim 3, further comprising:
a fifth MOS transistor having a source and a drain coupled to the second voltage, the fifth MOS transistor is turned on or off based on a third AC coupled control signal.

5. The apparatus of claim 3, further comprising:
a first AC coupling capacitor coupled to a gate of the third MOS transistor, the first AC coupling capacitor receives the first control signal and provides the first AC coupled control signal to the third MOS transistor; and
a second AC coupling capacitor coupled to a gate of the fourth MOS transistor, the second AC coupling capacitor receives the second control signal and provides the second AC coupled control signal to the fourth MOS transistor.

6. The apparatus of claim 5, further comprising:
a first resistor coupled between the gate of the third MOS transistor and circuit ground, the first resistor biases the second capacitor with zero Volts; and
a second resistor coupled between the gate of the fourth MOS transistor and the second voltage, the second resistor biases the third capacitor with the second voltage.

7. The apparatus of claim 1, the first and third switches comprise first and second P-channel metal oxide semiconductor (PMOS) transistors, respectively, and the second and fourth switches comprise first and second N-channel metal oxide semiconductor (NMOS) transistors, respectively.

8. The apparatus of claim 7, the first and second control signals have non-negative voltage levels, the first AC coupled control signal has positive and negative voltage levels, and the second AC coupled control signal has negative voltage levels.

9. The apparatus of claim 7, the second PMOS transistor is turned on during a first phase by a negative voltage on the first AC coupled control signal and is turned off during a second phase by a positive voltage on the first AC coupled control signal.

10. The apparatus of claim 7, the second NMOS transistor is turned off during a first phase by a low voltage on the second AC coupled control signal and is turned on during a second phase by a high voltage on the second AC coupled control signal, the low voltage is below the second voltage, and the high voltage is above the second voltage.

11. An integrated circuit comprising:
a first metal oxide semiconductor (MOS) transistor coupled between a first voltage and a first end of a capacitor, and first MOS transistor is turned on or off based on a first control signal;
a second MOS transistor coupled between the first end of the capacitor and circuit ground, the second MOS transistor is turned on or off based on a second control signal;
a third MOS transistor coupled between a second end of the capacitor and circuit ground, the third MOS transistor is turned on or off based on a first AC coupled control signal; and
a fourth MOS transistor coupled between the second end of the capacitor and a second voltage, the fourth MOS transistor is turned on or off based on a second AC coupled control signal.

12. The integrated circuit of claim 11, the first and third MOS transistors comprise P-channel MOS (PMOS) transistors, and the second and fourth MOS transistors comprise N-channel MOS (NMOS) transistors.

13. The integrated circuit of claim 11, further comprising:
a first AC coupling capacitor coupled to a gate of the third MOS transistor, the first AC coupling capacitor receives the first control signal and provides the first AC coupled control signal to the third MOS transistor; and
a second AC coupling capacitor coupled to a gate of the fourth MOS transistor, the second AC coupling capacitor receives the second control signal and provides the second AC coupled control signal to the fourth MOS transistor.

14. The integrated circuit of claim 13, further comprising:
a first resistor coupled between the gate of the third MOS transistor and circuit ground, the first resistor biases the first AC coupling capacitor with zero Volts; and
a second resistor coupled between the gate of the fourth MOS transistor and the second voltage, the second resistor biases the second AC coupling capacitor with the second voltage.

15. The integrated circuit of claim 11, the third MOS transistor is turned on during a first phase by a negative voltage on the first AC coupled control signal and is turned off during a second phase by a positive voltage on the first AC coupled control signal, and the fourth MOS transistor is turned off during the first phase by a low voltage on the second AC coupled control signal and is turned on during the second phase by a high voltage on the second AC coupled control signal, the low voltage is below the second voltage, and the high voltage is above the second voltage.

16. An apparatus comprising:
a negative voltage generator to receive a positive input voltage and provide a negative output voltage, the negative voltage generator comprises first, second, third and fourth switches coupled to a capacitor, the first and second switches are controlled by first and second control signals, respectively, and the third and fourth switches are controlled by first and second AC coupled control signals, respectively; and
a logic circuit coupled to the negative voltage generator, the logic circuit using the negative output voltage as a lower power supply voltage.

17. A method comprising:
controlling a first switch coupled between a first voltage and a first end of a capacitor based on a first control signal;
controlling a second switch coupled between the first end of the capacitor and circuit ground based on a second control signal;
controlling a third switch coupled between a second end of the capacitor and circuit ground based on a first AC coupled control signal; and
controlling a fourth switch coupled between the second end of the capacitor and a second voltage based on a second AC coupled control signal.

18. The method of claim 17, further comprising:
generating the first AC coupled control signal by AC coupling the first control signal; and
generating the second AC coupled control signal by AC coupling the second control signal.

19. The method of claim 17, further comprising:
generating the first AC coupled control signal having an average voltage of zero Volts; and
generating the second AC coupled control signal having an average voltage determined by the second voltage.

20. The method of claim 17, the controlling the first switch comprises controlling a first metal oxide semiconductor (MOS) transistor with the first control signal, the controlling the second switch comprises controlling a second MOS transistor with the second control signal, the controlling the third switch comprises controlling a third MOS transistor with the first AC coupled control signal, and the controlling the fourth switch comprises controlling a fourth MOS transistor with the second AC coupled control signal.

21. An apparatus comprising:
means for controlling a first switch coupled between a first voltage and a first end of a capacitor based on a first control signal;
means for controlling a second switch coupled between the first end of the capacitor and circuit ground based on a second control signal;
means for controlling a third switch coupled between a second end of the capacitor and circuit ground based on a first AC coupled control signal; and
means for controlling a fourth switch coupled between the second end of the capacitor and a second voltage based on a second AC coupled control signal.

22. The apparatus of claim 21, further comprising:
means for generating the first AC coupled control signal by AC coupling the first control signal; and
means for generating the second AC coupled control signal by AC coupling the second control signal.

23. The apparatus of claim 21, further comprising:
means for generating the first AC coupled control signal having an average voltage of zero Volts; and
means for generating the second AC coupled control signal having an average voltage determined by the second voltage.
